(19) United States
(12) Patent Application Publication
(10) Pub. No.: US 2025/0062532 A1
(43) Pub. Date: Feb. 20, 2025

(54) ANTENNA STRUCTURE AND HEAT DISSIPATION DEVICE

(71) Applicant: Wistron NeWeb Corporation, Hsinchu (TW)

(72) Inventors: Chun-Kai CHEN, Hsinchu (TW); Cheng-Rui ZHANG, Hsinchu (TW); Jian-Zhong CHEN, Hsinchu (TW); Hong-Jun JIAN, Hsinchu (TW)

(21) Appl. No.: 18/800,348

(22) Filed: Aug. 12, 2024

(30) Foreign Application Priority Data
Aug. 14, 2023 (TW) 112130449

(51) Int. Cl. H01Q 5/307; H01Q 1/02

(52) U.S. Cl. CPC H01Q 5/307; H01Q 1/02

(57) ABSTRACT

An antenna structure is disposed on a metal unit and includes a first slot, a second slot, a grounding portion and a short-circuiting portion. The first slot is formed on the metal unit along an axis direction and configured to receive a signal feed. The second slot is formed on the metal unit along the axis direction and separated from the first slot by a distance along the axis direction. The grounding portion is coupled to the metal unit. The short-circuiting portion crosses the second slot and is coupled to the grounding portion.

### RELATED APPLICATION

This application claims the benefit of priority to Taiwan Patent Application No. 112130449, filed on Aug. 14, 2023. The entire content of the above identified application is incorporated herein by reference.

### BACKGROUND

### Technical Field

The present disclosure relates to an antenna structure and a heat dissipation device, and more particularly, to an antenna structure and a heat dissipation device having slot antenna structure.

### Description of Related Art

With the increasing demand for wireless transmission, general electronic devices are equipped with antennas for transmitting and receiving data wirelessly. However, with the development of mobile devices heading toward a thin-and-light trend, the size of antenna components in electronic devices must also be reduced. In addition, the antenna structure in current electronic devices is insufficient in providing Wi-Fi 6E bandwidth.

From this, developing an antenna structure with multiple antenna bandwidths in a limited space is a goal in the related industry.

### SUMMARY

It is an aspect of the present disclosure to provide an antenna structure that is disposed on a metal unit and includes a first slot, a second slot, a grounding portion, and a short-circuiting portion. The first slot is formed on the metal unit along an axis direction and is configured to receive a signal feed. The second slot is formed on the metal unit along the axis direction and is separated from the first slot by a distance along the axis direction. The grounding portion is coupled to the metal unit. The short-circuiting portion crosses the second slot and is coupled to the grounding portion.

It is another aspect of the present disclosure to provide an antenna structure that is disposed on a metal unit and includes a first slot, a second slot, a grounding portion and a short-circuiting portion. The first slot is formed on the metal unit and has a first length. The first slot is configured to receive a signal feed. The second slot is formed on the metal unit and has a second length. The second length is greater than the first length. The grounding portion is coupled to the metal unit. The short-circuiting portion crosses the second slot and is coupled to the grounding portion.

It is yet another aspect of the present disclosure to provide a heat dissipation device that includes a heat dissipation body and an antenna unit. The antenna unit is connected to the heat dissipation body and includes a metal unit and an antenna structure. The antenna structure is disposed on the metal unit and includes a first slot, a second slot, a grounding portion and a short-circuiting portion. The first slot is formed on the metal unit along an axis direction and is configured to receive a signal feed. The second slot is formed on the metal unit along the axis direction and is separated from the first slot by a distance along the axis direction. The grounding portion is coupled to the metal unit. The short-circuiting portion crosses the second slot and is coupled to the grounding portion. The first slot and the second slot are integrally formed with the metal unit.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of an antenna structure according to a first embodiment of the present disclosure.

FIG. 2 is a schematic diagram illustrating frequency path one, frequency path two, frequency path three, and frequency path four of the antenna structure shown in FIG. 1.

FIG. 3 is a schematic diagram illustrating frequency path five and frequency path six of the antenna structure shown in FIG. 1.

FIG. 4 is a schematic diagram illustrating frequency path seven, frequency path eight, and frequency path nine of the antenna structure shown in FIG. 1.

FIG. 5 is a graph illustrating the overall bandwidth waveform of the frequency and return loss of the antenna structure shown in FIG. 1.

FIG. 6A is a schematic diagram of a heat dissipation device according to a second embodiment of the present disclosure.

FIG. 6B is a schematic diagram of a heat dissipation device according to a third embodiment of the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

In the present disclosure, when an element (i.e. a unit or a module) is described to “connect” to another element, it means to that the element is directly connected to the other element, or that certain element is indirectly connected to the other element, which implies that there is another element between the element and the other element. When an element is described to “directly connect” to another element, it means to no other element is between the element and the other element.

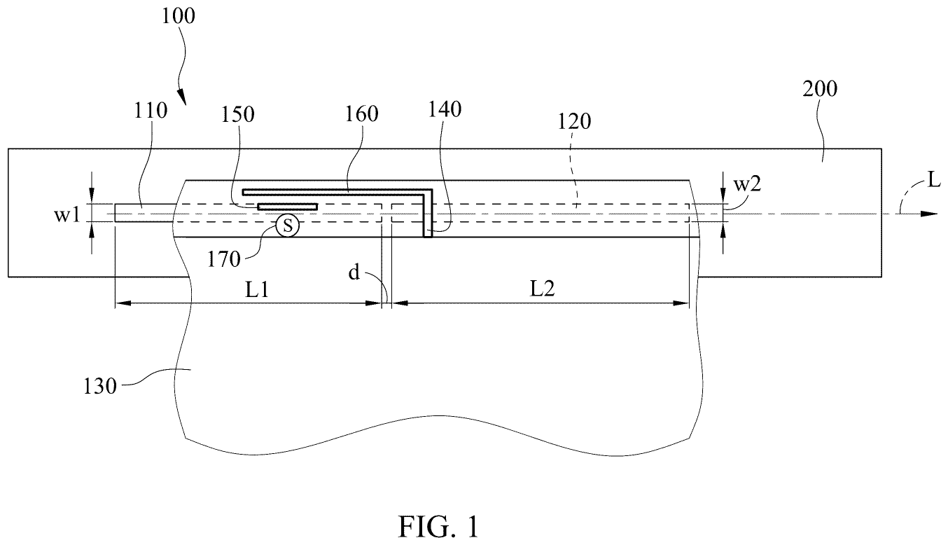

FIG. 1 is a schematic diagram of an antenna structure 100 according to a first embodiment of the present disclosure. Referring to FIG. 1, the antenna structure 100 is disposed on a metal unit 200 and includes a first slot 110, a second slot 120, a grounding portion 130, a short-circuiting portion 140, a first radiating portion 150, a second radiating portion 160 and a feeding portion 170. The first slot 110 and the second slot 120 are formed on the metal unit 200. The grounding portion 130 is coupled to the metal unit 200. The short-circuiting portion 140 is coupled to the grounding portion 130 and the second radiating portion 160, and the feeding portion 170 is coupled to the first radiating portion 150.

In the first embodiment, the grounding portion 130, the short-circuiting portion 140, the first radiating portion 150, the second radiating portion 160, and the feeding portion 170 may be formed on the surface of a carrier such as a flexible printed circuit (FPC), but the present disclosure is not limited thereto. In other embodiments, the grounding portion 130 may be formed on the metal unit 200. In the first embodiment, the positions of the grounding portion 130, the short-circuiting portion 140, the first radiating portion 150, the second radiating portion 160, and the feeding portion 170 on the carrier correspond to the positions of the first slot 110 and the second slot 120 on the metal unit 200, thereby fixing the relative positions between the carrier and the metal unit 200 to form the antenna structure 100.

In the first embodiment, the metal unit 200 may be disposed on the surface of a printed circuit board (PCB) or integrally formed on the housing structure of an electronic device (such as a laptop, personal digital assistant, or other portable electronic devices), but the present disclosure is not limited thereto. The first slot 110 and the second slot 120 are closed slots. The grounding portion 130 is a ground copper foil and is coupled to a system ground of the electronic device, but the present disclosure is not limited thereto.

Referring to FIG. 1, the first slot 110 and the second slot 120 are formed on the metal unit 200 along an axis direction L. The first slot 110 is configured to receive a signal feed, and the second slot 120 is separated from the first slot 110 by a distance d along the axis direction L. The first slot 110 has a first length L1 and a first width w1, and the second slot 120 has a second length L2 and a second width w2. The second length L2 is greater than the first length L1, and both the first length L1 and the second length L2 are greater than the distance d. The first width w1 is equal to the second width w2. In the first embodiment, the first length L1 is 45 millimeters, the second length L2 is 50 millimeters, the distance d is 2 millimeters, and both the first width w1 and the second width w2 are 2 millimeters, but the present disclosure is not limited thereto.

Referring to FIG. 1, the short-circuiting portion 140 crosses the second slot 120 in a direction perpendicular to the axis direction L. One end of the short-circuiting portion 140 is coupled to the grounding portion 130, and the other end is coupled to the second radiating portion 160. The first radiating portion 150 and the second radiating portion 160 are parallel to the axis direction L. The second radiating portion 160 extends from the second slot 120 towards the direction of the first slot 110 and is located at one side of the first radiating portion 150. The first radiating portion 150 is located between the second radiating portion 160 and the first slot 110. The length of the second radiating portion 160 is greater than the length of the first radiating portion 150 but less than the first length L1. In the first embodiment, the length of the first radiating portion 150 is 10 millimeters, and the length of the second radiating portion 160 is 27 millimeters, but the present disclosure is not limited thereto. In other embodiments, the short-circuiting portion 140 crosses the second slot 120 in a direction intersecting with the axis direction L. In other words, the short-circuiting portion 140 extends from one end of the second radiating portion 160 towards the grounding portion 130 and is not parallel to the axis direction L.

Referring to FIG. 1, the vertical projection of the feeding portion 170 on the metal unit 200 partially overlaps the first slot 110. The feeding portion 170 is electrically connected to a coaxial transmission line (not shown) and coupled to a signal source S to receive signal feeds. Specifically, signals are fed from the feeding portion 170 to the first radiating portion 150, and after feeding into the first radiating portion 150, the signals are coupled to the second radiating portion 160, forming resonance at the first slot 110 and the second slot 120 to generate transmission signals of multiple frequency bands.

Therefore, the antenna structure 100 of the present disclosure utilizes the positional arrangement of the first slot 110, the second slot 120, the short-circuiting portion 140, the first radiating portion 150, the second radiating portion 160, and the feeding portion 170 to excite transmission signals of multiple frequency bands, providing a wider bandwidth and better antenna efficiency.

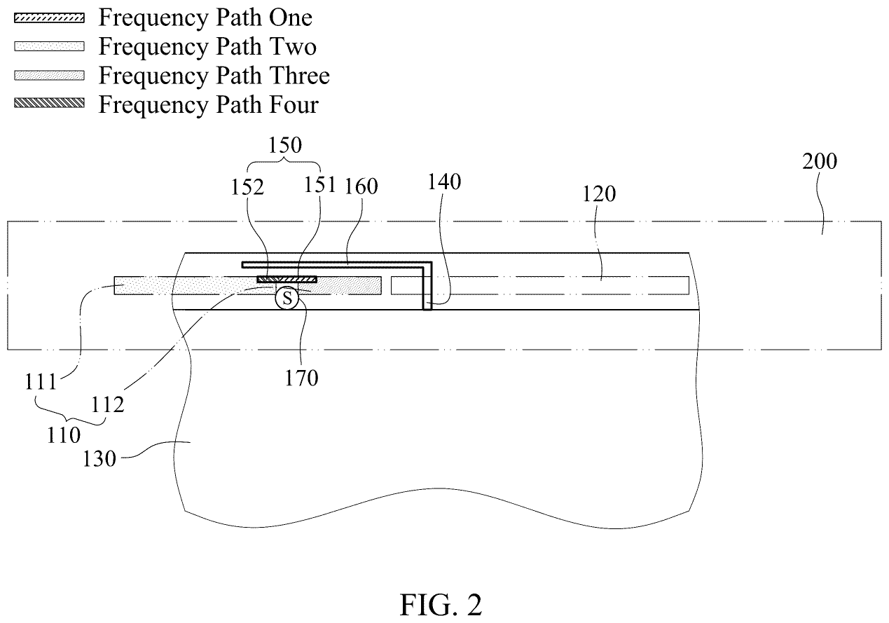

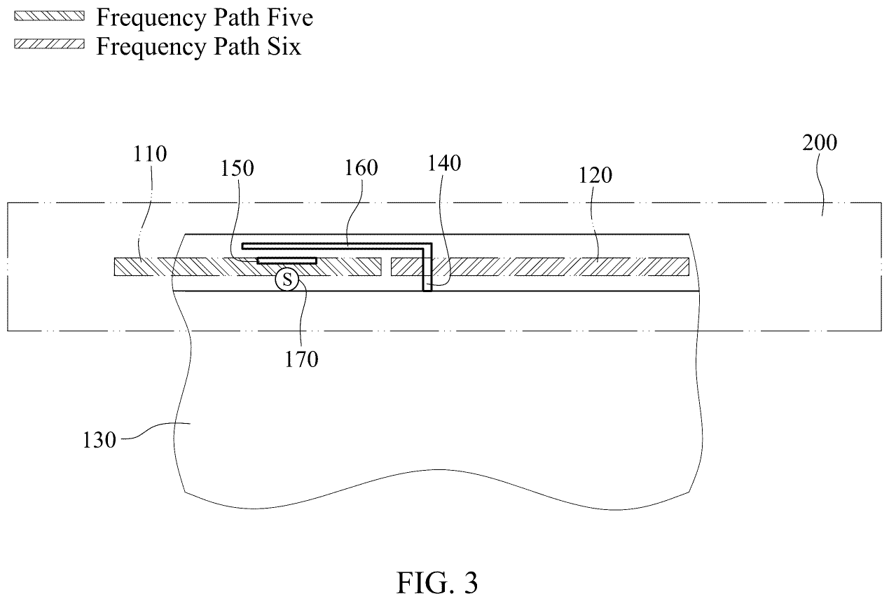

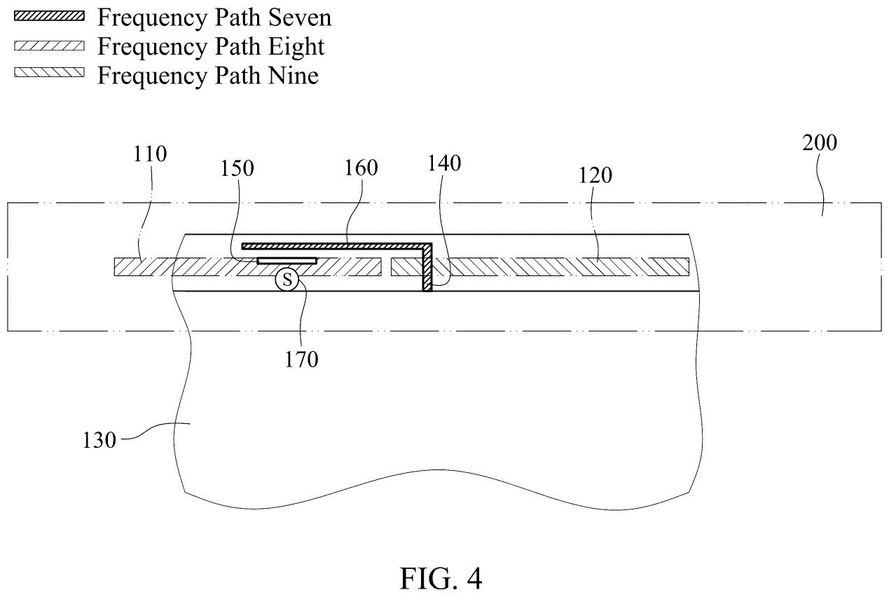

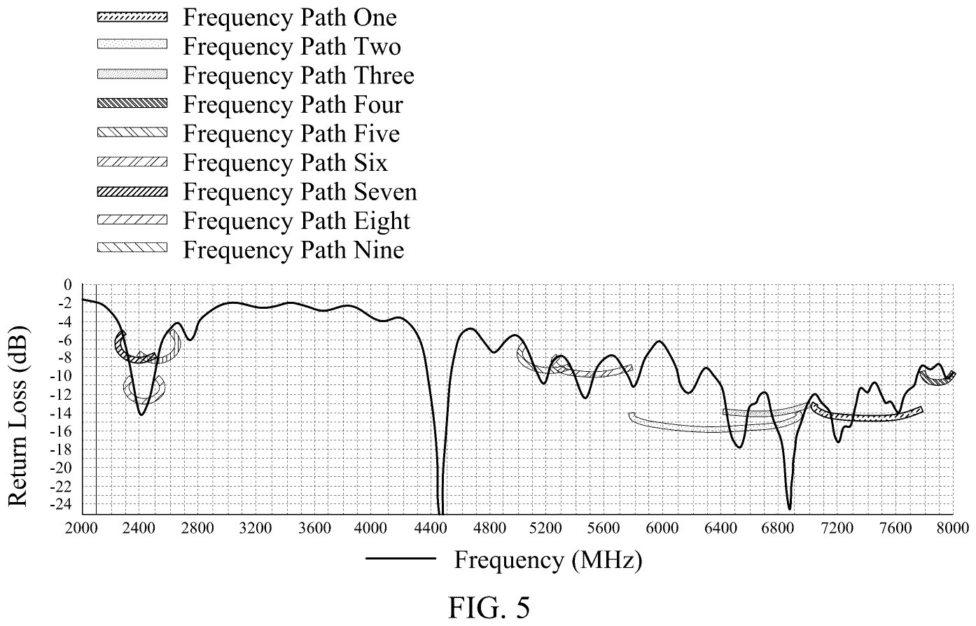

FIG. 2 is a schematic diagram illustrating frequency path one, frequency path two, frequency path three, and frequency path four of the antenna structure 100 shown in FIG. 1. FIG. 3 is a schematic diagram illustrating frequency path five and frequency path six of the antenna structure 100 shown in FIG. 1. FIG. 4 is a schematic diagram illustrating frequency path seven, frequency path eight, and frequency path nine of the antenna structure 100 shown in FIG. 1. FIG. 5 is a graph illustrating the overall bandwidth waveform of the frequency and return loss of the antenna structure 100 shown in FIG. 1.

Referring to FIGS. 2 and 5, the antenna structure 100 provides frequency paths one, two, three, and four through the first radiating portion 150. The first radiating portion 150 includes a first branch 151 and a second branch 152. After the signal is fed into the first radiating portion 150 by the feeding portion 170, the current splits into two paths and moves towards both ends of the first radiating portion 150, forming the first branch 151 and the second branch 152. The first slot 110 is cutoff by the feeding portion 170 and divided into a first portion 111 and a second portion 112. The first branch 151, with its own length, forms frequency path one, providing a resonant frequency between 7000 MHz and 7800 MHZ. The first radiating portion 150 couples with the first portion 111 to form frequency path two, providing a resonant frequency between 5800 MHZ and 6900 MHZ. The first radiating portion 150 couples with the second portion 112 to form frequency path three, providing a resonant frequency between 6400 MHz and 7000 MHz. The second branch 152, with its own length, forms frequency path four, providing a resonant frequency between 7800 MHz and 8000 MHz. The first branch 151 and the second branch 152 are not equal in length; the first portion 111 and the second portion 112 are not equal in length. In the first embodiment, the length of the first branch 151 is greater than the length of the second branch 152; the length of the first portion 111 is greater than the length of the second portion 112.

Therefore, the frequency path one formed by the first branch 151 itself can provide some high-frequency characteristics. The frequency paths two and three formed by the coupling and excitation of the first radiating portion 150 with the first portion 111 and the second portion 112, respectively, can provide other high-frequency characteristics. The frequency path four formed by the second branch 152 can provide Wi-Fi 6E characteristics.

Referring to FIGS. 3 and 5, the antenna structure 100 provides frequency paths five and six through the first radiating portion 150 and the second radiating portion 160. The first radiating portion 150 couples with the first slot 110 to form frequency path five, providing a resonant frequency between 5100 MHz and 5300 MHz. After the signal is fed into the first radiating portion 150 by the feeding portion 170, it is coupled to the second radiating portion 160. The second radiating portion 160 coupled with the short-circuiting portion 140, excites the second slot 120 to form frequency path six, providing a resonant frequency between 5300 MHz and 5800 MHZ.

Therefore, the frequency path five formed by the coupling and excitation of the entire first slot 110 by the first radiating portion 150 can also provide Wi-Fi 6E characteristics. The frequency path six formed by the coupling and excitation of the second slot 120 by the second radiating portion 160 and the short-circuiting portion 140 can provide additional high-frequency characteristics.

Referring to FIGS. 4 and 5, the antenna structure 100 provides frequency paths seven, eight, and nine through the first radiating portion 150 and the second radiating portion 160. After the signal is fed into the first radiating portion 150 by the feeding portion 170, it is coupled to the second radiating portion 160. The second radiating portion 160 and the short-circuiting portion 140, with their combined lengths, form frequency path seven, providing a resonant frequency between 2300 MHz and 2500 MHz. The first radiating portion 150 couples and excites the first slot 110 to form frequency path eight, providing a resonant frequency between 2350 MHz and 2500 MHz. After the signal is fed into the first radiating portion 150 by the feeding portion 170, it is coupled to the second radiating portion 160. The second radiating portion 160 coupled with the short-circuiting portion 140, excites the second slot 120 to form frequency path nine, providing a resonant frequency between 2400 MHz and 2600 MHZ. The frequency band of frequency path five is the high-order mode of the frequency band of frequency path eight, and the frequency band of frequency path six is the high-order mode of the frequency band of frequency path nine.

Therefore, the frequency path seven formed by the combined lengths of the second radiating portion 160 and the short-circuiting portion 140 can provide some low-frequency characteristics. The frequency path eight formed by the coupling and excitation of the first slot 110 by the first radiating portion 150, and the frequency path nine formed by the coupling and excitation of the second slot 120 by the second radiating portion 160 and the short-circuiting portion 140, can provide better low-frequency characteristics with improved radiation efficiency.

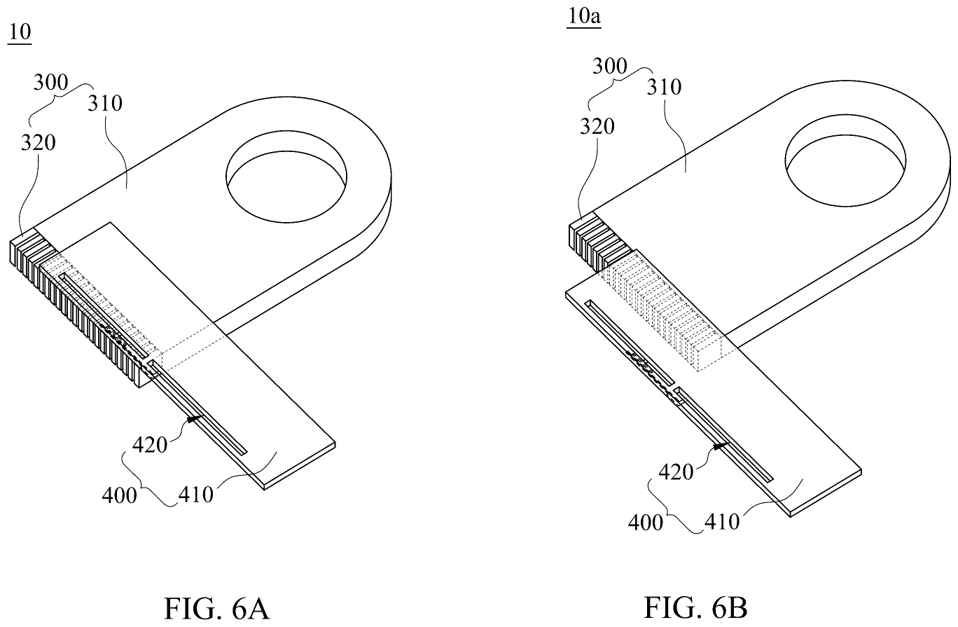

FIG. 6A is a schematic diagram of a heat dissipation device 10 according to a second embodiment of the present disclosure. FIG. 6B is a schematic diagram of a heat dissipation device 10a according to a third embodiment of the present disclosure. Referring to FIGS. 1, 6A and 6B, the heat dissipation devices 10, 10a include a heat dissipation body 300 and an antenna unit 400. The heat dissipation body 300 includes a housing 310 and a heat sink 320. The antenna unit 400 is connected to the heat dissipation body 300 and includes a metal unit 410 and an antenna structure 420. The antenna structure 420 is disposed on the metal unit 410 and includes a first slot, a second slot, a grounding portion and a short-circuiting portion (un labeled). In the second and third embodiments, the antenna structure 420 is the same as the antenna structure 100 in the first embodiment and will not be described herein.

The antenna unit 400 can be integrated with the heat dissipation body 300 in different ways according to the spatial configuration of the heat dissipation devices 10, 10a, overcoming the limitation on the antenna position. Specifically, referring to FIG. 6A, the metal unit 410 is coupled to the housing 310. Referring to FIG. 6B, the metal unit 410 is coupled to the heat sink 320. In the second and third embodiments, the heat dissipation devices 10, 10a are attached to electronic devices. The heat dissipation devices 10, 10a can be the cooling fans of laptops, but the present disclosure is not limited thereto.

In view of the above, the present disclosure has the following advantages. First, the antenna structure of the present disclosure can excite transmission signals in multiple frequency bands by utilizing the positional arrangement of the first slot, the second slot, the short-circuiting portion, the first radiating portion, the second radiating portion and the feeding portion. Second, the resonant frequencies excited by the antenna structure of the present disclosure can meet the Wi-Fi 6E frequency band requirements, providing a wider bandwidth and better antenna efficiency. Third, the antenna structure of the present disclosure can be integrated with the device according to the spatial configuration of the device in which it is installed, overcoming the limitation on antenna positioning.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An antenna structure disposed on a metal unit, the antenna structure comprising:
a first slot formed on the metal unit along an axis direction and configured to receive a signal feed;
a second slot formed on the metal unit along the axis direction and separated from the first slot by a distance along the axis direction;
a grounding portion coupled to the metal unit; and
a short-circuiting portion crossing the second slot and coupled to the grounding portion.

2. The antenna structure according to claim 1, further comprising:
a first radiating portion; and
a second radiating portion coupled to the short-circuiting portion and extending from the second slot toward the first slot, wherein the second radiating portion is located at one side of the first radiating portion;
wherein the first radiating portion and the second radiating portion are parallel to the axis direction, and the first radiating portion is positioned between the second radiating portion and the first slot.

3. The antenna structure according to claim 2, wherein a length of the second radiating portion is greater than a length of the first radiating portion.

4. The antenna structure according to claim 2, further comprising:
a feeding portion disposed on the metal unit and partially overlapping the first slot, wherein the feeding portion is configured to provide the signal feed.

5. The antenna structure according to claim 4, wherein the first slot is cutoff by the feeding portion and divided into a first portion and a second portion, and the first portion and the second portion are not equal in length.

6. The antenna structure according to claim 5, wherein
a resonant frequency of the first radiating portion coupling with the first portion is between 5800 MHz and 6900 MHz; and
a resonant frequency of the first radiating portion coupling with the second portion is between 6400 MHz and 7000 MHz.

7. The antenna structure according to claim 2, wherein
a resonant frequency of the first radiating portion coupling with the first slot in a high-order mode is between 5100 MHz and 5300 MHz;
a resonant frequency of the first radiating portion coupling with the first slot is between 2350 MHz and 2500 MHZ;
a resonant frequency of the second radiating portion and the short-circuiting portion coupling with the second slot in a high-order mode is between 5300 MHz and 5800 MHZ;
a resonant frequency of the second radiating portion and the short-circuiting portion coupling with the second slot is between 2400 MHz and 2600 MHZ, and
a resonant frequency of the second radiating portion and the short-circuiting portion is between 2300 MHz and 2500 MHz.

8. The antenna structure according to claim 2, wherein the first radiating portion comprises:
a first branch for providing a resonant frequency between 7000 MHz to 7800 MHz; and
a second branch for providing a resonant frequency between 7800 MHz to 8000 MHz.

9. An antenna structure disposed on a metal unit, the antenna structure comprising:
a first slot formed on the metal unit and having a first length, wherein the first slot is configured to receive a signal feed;
a second slot formed on the metal unit and having a second length, wherein the second length is greater than the first length;
a grounding portion coupled to the metal unit; and
a short-circuiting portion crossing the second slot and coupled to the grounding portion.

10. The antenna structure according to claim 9, wherein the first slot and the second slot are formed on the metal unit along an axis direction and are separated by a distance along the axis direction.

11. The antenna structure according to claim 10, further comprising:
a first radiating portion; and
a second radiating portion coupled to the short-circuiting portion and extending from the second slot toward the first slot, wherein the second radiating portion is located at one side of the first radiating portion;
wherein the first radiating portion and the second radiating portion are arranged parallel to the axis direction, and the first radiating portion is positioned between the second radiating portion and the first slot.

12. The antenna structure according to claim 11, wherein a length of the second radiating portion is greater than a length of the first radiating portion, and the length of the second radiating portion is less than the first length.

13. The antenna structure according to claim 11, further comprising:
a feeding portion disposed on the metal unit and partially overlapping the first slot, wherein the feeding portion is configured to provide the signal feed.

14. The antenna structure according to claim 13, wherein the first slot is cutoff by the feeding portion and divided into a first portion and a second portion, and the first portion and the second portion are not equal in length.

15. The antenna structure according to claim 14, wherein
a resonant frequency of the first radiating portion coupling with the first portion is between 5800 MHz and 6900 MHz; and
a resonant frequency of the first radiating portion coupling with the second portion is between 6400 MHz and 7000 Mhz.

16. The antenna structure according to claim 11, wherein
a resonant frequency of the first radiating portion coupling with the first slot in a high-order mode is between 5100 MHz and 5300 Mhz;
a resonant frequency of the first radiating portion coupling with the first slot is between 2350 MHz and 2500 MHZ;
a resonant frequency of the second radiating portion and the short-circuiting portion coupling with the second slot in a high-order mode is between 5300 MHZ and 5800 MHZ;
a resonant frequency of the second radiating portion and the short-circuiting portion coupling with the second slot is between 2400 MHz and 2600 MHz; and
a resonant frequency of the second radiating portion and the short-circuiting portion is between 2300 MHz and 2500 MHz.

17. The antenna structure according to claim 11, wherein the first radiating portion comprises:
a first branch for providing a resonant frequency between 7000 MHz to 7800 MHz; and
a second branch for providing a resonant frequency between 7800 MHz to 8000 MHz.

18. A heat dissipation device comprising:
a heat dissipation body; and
an antenna unit connected to the heat dissipation body and comprising:
a metal unit; and
an antenna structure disposed on the metal unit and comprising:
a first slot formed on the metal unit along an axis direction and configured to provide a signal feed;
a second slot formed on the metal unit along the axis direction and separated from the first slot by a distance along the axis direction;
a grounding portion coupled to the metal unit; and
a short-circuiting portion crossing the second slot and coupled to the grounding portion;
wherein the first slot and the second slot are integrally formed with the metal unit.

19. The heat dissipation device according to claim 18, wherein the heat dissipation body comprises:
a housing; and
a heat sink;
wherein the metal unit is coupled to one of the housing and the heat sink.

20. The heat dissipation device according to claim 18, wherein the antenna structure further comprising:
a first radiating portion;
a second radiating portion coupled to the short-circuiting portion and extending from the second slot toward the first slot, wherein the second radiating portion is located at one side of the first radiating portion; and
a feeding portion disposed on the metal unit and partially overlapping the first slot, wherein the feeding portion is configured to provide the signal feed;
wherein the first radiating portion and the second radiating portion are arranged parallel to the axis direction, and the first radiating portion is positioned between the second radiating portion and the first slot.
